(19) United States
(12) Patent Application Publication
(10) Pub. No.: US 2003/0090746 A1
(43) Pub. Date: May 15, 2003

(54) Shaft sleeve of a scanner

(76) Inventors: Mei-Wen Huang, MiaoLi (TW); Chien-Liang Yeh, Hsinchu (TW)

Correspondence Address: Raymond Sun, 12420 Woodhall Way, Tustin, CA, 92782, US

(21) Appl. No.: 10/010,588

(22) Filed: Nov. 13, 2001

(51) Int. Cl. H04N 1/04

(52) U.S. Cl. 358/498

(57) ABSTRACT

The present invention is to provide a shaft sleeve of a scanner, the scanner having an optical chassis that is capable of moving along the linear direction defined by a guiding rod, comprising: an trunk, a wedging mechanism, and a transmission part. The trunk having a gliding groove capable of connected with the guiding rod. The wedging mechanism provided at one side of the trunk, capable of connecting with the optical chassis. The transmission part provided on the trunk and connected with a driving device, for enabling the truck to move along the linear direction defined by the guiding rod. The optical chassis is capable of choosing a connection with the shaft sleeve to move along the linear direction defined by the guiding rod or the optical chassis is capable of choosing a separation from the shaft sleeve.

### FIELD OF THE INVENTION

The present invention relates to a shaft sleeve, especially to a kind of shaft sleeve of a scanner that is capable of connecting with or separating from an optical chassis of scanner.

### BACKGROUND OF THE INVENTION

Recently, because the abrupt progress of high technology, especially the relative field of manufacturing procedures for micro-electronic products is improved daily, computer has already penetrated into each family and business to become an electronic necessity that is indispensable in modern lives. Following the prevalence of computer multimedia, more peripheral products are needed for making input and output. Because of the continuous innovation of the technology of optical-electronic semiconductor, the product technology of relative peripheral device for computer such as optical scanner, etc. has become more mature and more popular day by day, and become a necessary product for the peripheral devices of computer.

Please refer to FIG. 1A, which is a structure illustration of an embodiment for the optical scanner of prior arts. The main structure characteristic is that a document window glass 12 is provided at the upper side surface of the outer shell 11 of an optical scanner 1 for placing a document manuscript 16 to be scanned. By the actuation of a driving device 13, an optical chassis 14 proceeds a linear motion along the direction of a guiding rod 15 in the hollow outer shell 11 to execute image-scanning job on a document manuscript 16 to be scanned on the document window glass 12.

Please refer to FIG. 1B, which is a structure illustration for the shaft sleeve of a scanner of prior arts. Wherein, one end surface of the optical chassis 14 has a shaft sleeve 17 that is manufactured and formed into one body with the optical chassis 14. And, the shaft sleeve 17 may be connected with the driving device 13 that is a power source (not shown in the drawing) driving a belt 131 with appropriate gear ratio. The belt 131 may be connected with the optical chassis 14. Therefore, when the driving device 13 drives the shaft sleeve 17 to move, the optical chassis 14 may be moved synchronically with the shaft sleeve 17. By the guidance of the guiding rod 15, the optical chassis 14 may make a linear displacement motion along the extension direction of the guiding rod 15 for executing scanning motion.

Since the shaft sleeve 17 for scanner of prior arts is manufactured and formed into one body with the optical chassis 14, so the optical chassis 14 is connected on the guiding rod 15. Therefore, when the optical chassis 14 is slightly damaged and has to be changed, the outer shell 11 of the optical scanner 1 has to be dismantled entirely. The optical chassis is drawn out and separated apart firstly, then the change is proceeded. After the optical chassis 14 has been changed, then the assembly is proceeded again. When different resolution for scanning is needed, the optical chassis 14 also has to be changed according to above-mentioned manners. Therefore, it causes inconvenience for changing and assembling the optical scanner 1. Therefore, the requirement of convenience for applying the optical scanner and how to execute an optimal scanning have become the urgent problems to be solved and improved by the relative businessmen of scanner manufacturing industries.

### SUMMARY OF THE INVENTION

The main object of the present invention is to provide an shaft sleeve of a scanner, which may provide the functions of separating apart and connecting together with the optical chassis of a scanner to reach the modularization of shaft sleeve that is capable of being applied to the connection job of different optical chassis.

The secondary object of the present invention is to provide an shaft sleeve of a scanner, which may prevent the driving belt from dropping off and reduce the bump and separation between the shaft sleeve and the driving device during moving.

To fulfill above-mentioned objects, a shaft sleeve of a scanner has been invented. The scanner having an optical chassis that is capable of moving along the linear direction defined by a guiding rod. The shaft sleeve of a scanner comprising: an trunk, a wedging mechanism, and a transmission part.

The trunk has a gliding groove capable of connecting with the guiding rod.

The wedging mechanism provided at one side of the trunk, capable of connecting with the optical chassis.

The transmission part provided on the trunk and connected with a driving device, for enabling the truck to move along the linear direction defined by the guiding rod.

Wherein, the optical chassis is capable of choosing a connection with the shaft sleeve to move along the linear direction defined by the guiding rod or the optical chassis is capable of choosing a separation from the shaft sleeve.

For your esteemed reviewing committee to further understand and recognize the present invention, a detailed description in cooperation with corresponding drawings are presented as following.

### BRIEF DESCRIPTION OF THE DRAWINGS

FIG. 1A is an illustration of three-dimensional structure for the flatbed-typed optical scanner of prior arts.

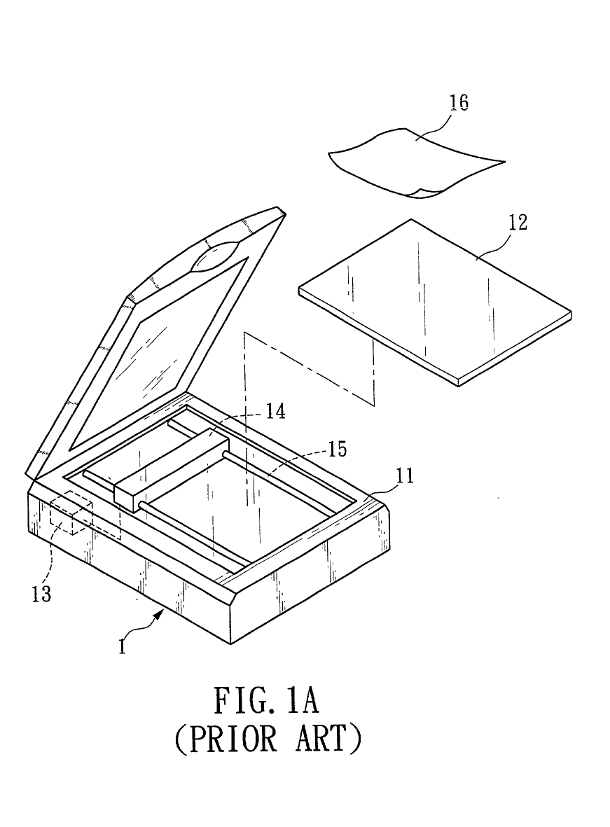

FIG. 1B is an illustration of three-dimensional structure for the shaft sleeve of a scanner of prior arts.

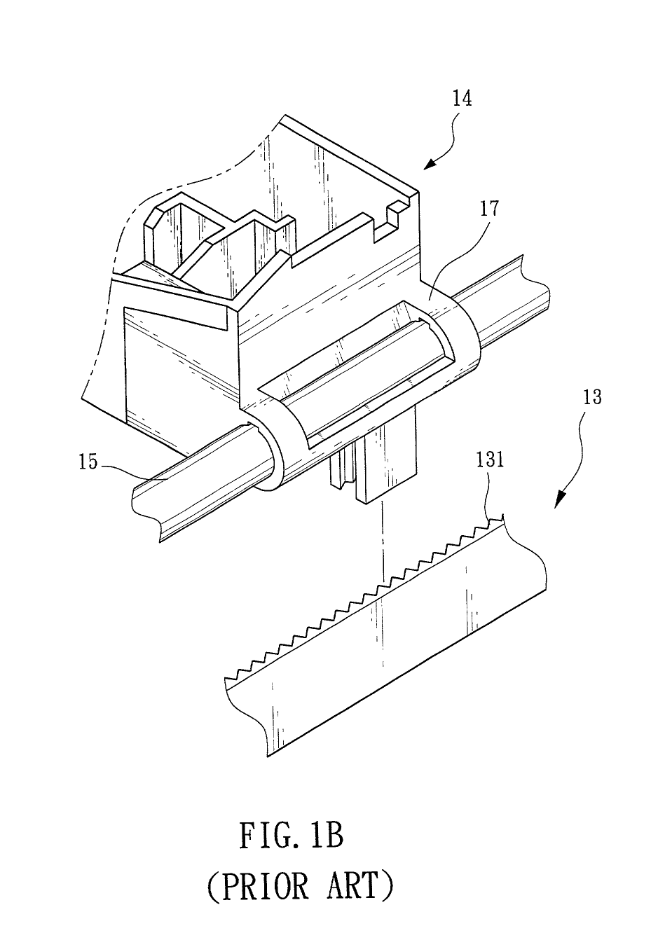

FIG. 2A is an illustration of three-dimensional structure for a preferred embodiment of the optical scanner of the present invention.

FIG. 2B is an implementing illustration of three-dimensional structure for the first preferred embodiment of the shaft sleeve of a scanner of the present invention.

FIG. 2C is an implementing illustration of another viewing angle for the three-dimensional structure of the first preferred embodiment of the shaft sleeve of a scanner of the present invention.

FIG. 2D is an implementing illustration for the three-dimensional separated structures of the first preferred embodiment of the shaft sleeve of a scanner in cooperation with both the driving device and the optical chassis of the present invention.

FIG. 2E is an implementing illustration for the three-dimensional separated structures of the first preferred embodiment of the shaft sleeve of a scanner in cooperation with both the driving device and the optical chassis of the present invention.

FIG. 3A is an implementing illustration for the three-dimensional separated structures of the second preferred embodiment of the shaft sleeve of a scanner in cooperation with both the driving device and the optical chassis of the present invention.

FIG. 3B is an implementing illustration for the three-dimensional separated structures of the second preferred embodiment of the shaft sleeve of a scanner in cooperation with both the driving device and the optical chassis of the present invention.

### DETAILED DESCRIPTION OF THE PREFERRED EMBODIMENT

The main characteristic of the shaft sleeve of a scanner of the invention is that the optical chassis may choose a connection with the shaft sleeve to make a linear displacement motion along the extension direction of the guiding rod or the optical chassis may choose a separation from the shaft sleeve.

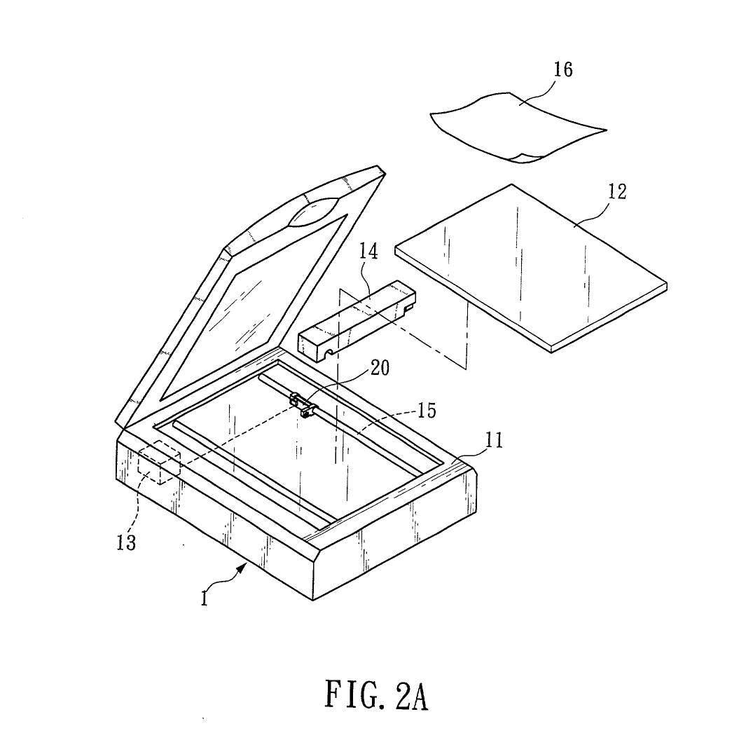

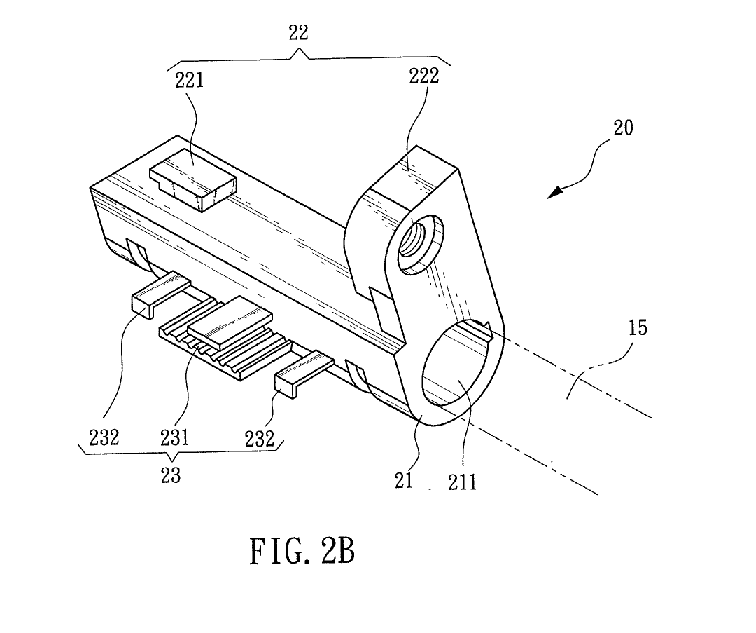

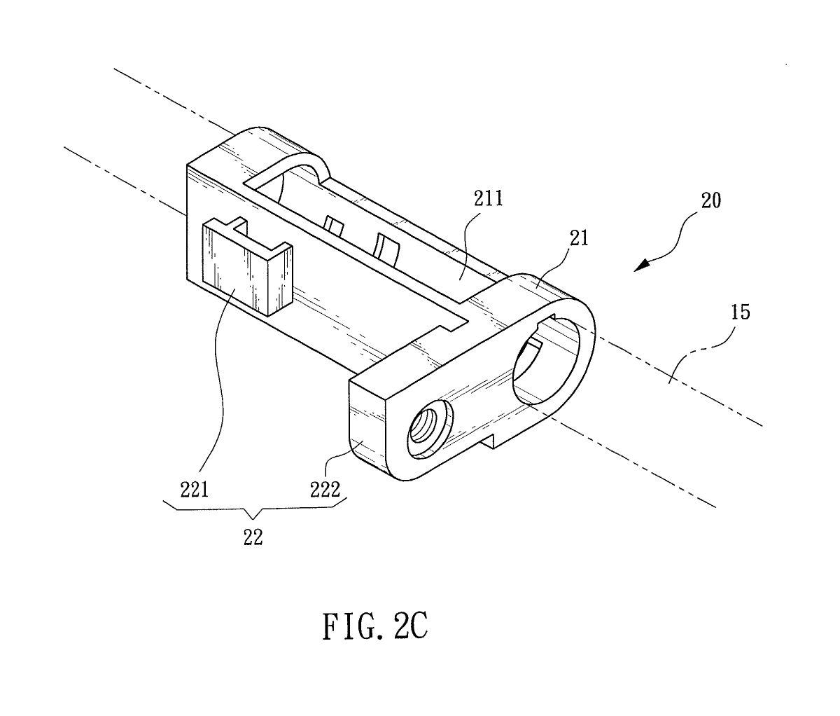

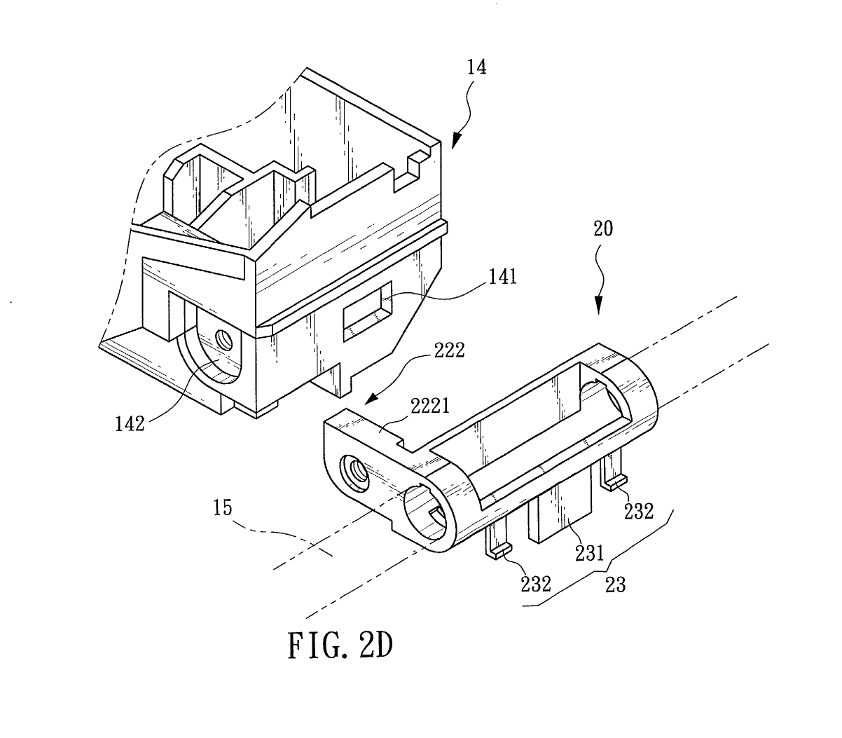

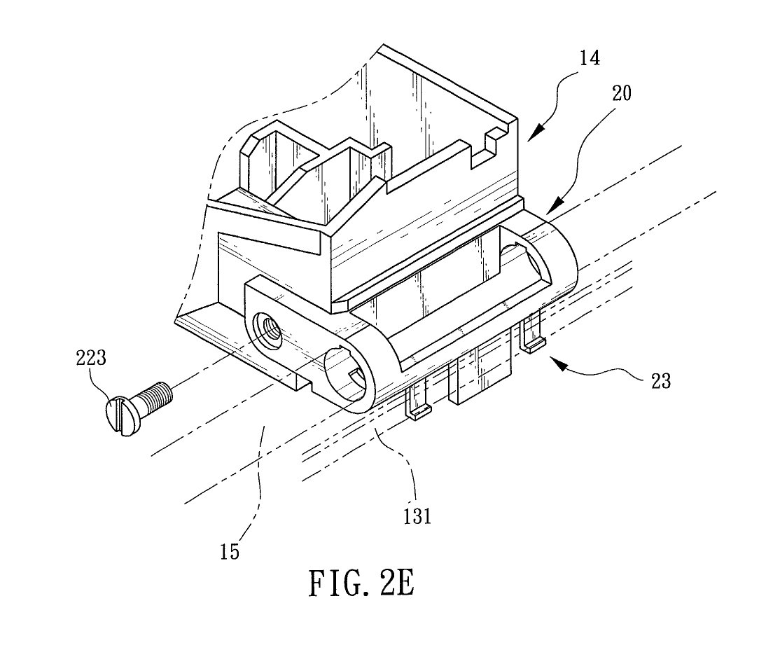

Please refer to FIG. 2A through FIG. 2E, which are the preferred implementing illustrations for the three-dimensional structures and assembling connections for the preferred embodiments for the shaft sleeve of a scanner and the scanner of the present invention. When the optical scanner 1 of the present invention as shown in FIG. 2A executes the image-scanning job on the document manuscript 16 to be scanned, a document window glass 12 is arranged at the upper side surface of the outer shell 11 of the optical scanner 1 for placing a document manuscript 16 to be scanned. The optical scanner 1 is arranged with an optical chassis 14. By the actuation of a driving device 13 and the guidance of a guiding rod 15, the optical chassis 14 may make a linear motion along the extension direction of the guiding rod 15 in the hollow outer shell 11 to proceed image-scanning job on the document manuscript 16 to be scanned on the document window glass 12. Wherein, one end surface of the optical chassis 14 may be connected to a shaft sleeve 20 of a scanner. In the preferred embodiments of the invention, the shaft sleeve 20 of a scanner is designed as only one shaft sleeve 20 of a scanner. The shaft sleeve 20 of a scanner is connected to one end of the optical chassis 14. And, the connection of both the shaft sleeve 20—of a scanner and the driving device 13 is the active end that drives the optical chassis 14, while another end of the optical chassis 14 is connected with the guiding rod 15 to become a moving passive end. Of course, it may also be that the shaft sleeve 20 of a scanner is designed in corresponding to two ends of the optical chassis 14. Therefore, the number of the shaft sleeve 20 of a scanner could be two. Such kinds of variation of structures are well known to those who are skilled in the arts and may be modified and implemented according to above disclosure without losing the merit of the present invention and departing from the spirit and scope of the present invention, so more detailed description is not repetitiously presented herein.

Please refer to FIG. 2B through FIG. 2E, which are illustrations for preferred embodiment of the shaft sleeve 20 of a scanner for the present invention. Wherein, the shaft sleeve 20 of a scanner includes: a trunk 21, a wedging mechanism 22, and a transmission part 23. The trunk 21 has a gliding groove 211 capable of connected with the guiding rod 15. In the preferred embodiment of the invention, the guiding rod 15 is a round rod. Therefore, the gliding groove 211 is designed as a hole groove of round pillar. Of course, the guiding rod 15 may also be a square rod, and the gliding groove 211 is designed as a hole groove of square. Or, an axle bushing (not shown in the drawings) is arranged to make the gliding groove 211 be able to be matched with the guiding rod 15 to make sure that the trunk 21 may be connected with the guiding rod 15 to make a linear displacement motion along the extension direction of the guiding rod 15. Such kinds of variation of structures are well known to those who are skilled in the arts and may be modified and implemented according to above disclosure without losing the merit of the present invention and departing from the spirit and scope of the present invention, so more detailed description is not repetitiously presented herein.

The wedging mechanism 22 is arranged at one side of the trunk 21 and may be applied to proceed the connection with the optical chassis 14. In the preferred embodiment of the invention, the wedging mechanism 22 is arranged with a protrusion-fixing part 221 and a lock-fixing part 222. The protrusion-fixing part 221 is arranged at one side of the trunk 21. The optical chassis 14 is further arranged with a recessed groove 141, of which shape is matched with the protrusion-fixing part 221 and may provide the setting-in for the protrusion-fixing part 221. The protrusion-fixing part 221 is wedged and connected with the optical chassis 14 by setting itself into the recessed groove 141. And, the lock-fixing part 222 is extended through out one side of the trunk 21 and has a protrusion edge 2221. The optical chassis 14 is arranged with a corresponding recessed hole 142. By setting the protrusion edge 2221 into the recessed hole 142, both the wedging mechanism 22 and the optical chassis 14 are positioned and connected together. Again, a bolt 223 is applied for locking and connecting both the lock-fixing part 222 and the optical chassis 14 to become one body.

The transmission part 23 arranged at the trunk 14 may be connected with the driving device 13. In the preferred embodiment of the invention, the transmission part 23 includes a wedge-setting part 231 and at least a reverse hook 232. The wedge-setting part 231 is arranged at one side of the trunk 21 and protruded out the trunk 21. The reverse hook 232 is kept an appropriate distance with the wedge-setting part 231. In the preferred embodiment of the invention, the number of the reverse hook is two and they are located at two sides of the wedge-setting part 231. The reverse hook 232 is designed as an “L” shape. Of course, its number may also be one or more. And, it may also be located at other positions or belonged to other shapes. Such kinds of variations of number, position, and shape are well known to those who are skilled in such arts, so repetitious description is not presented herein. The driving device 13, a power source (not shown in the drawings) drives a belt 131 with appropriate gear ratio. The preferred belt 131 is designed as a belt having a tooth contour. The tooth contour of the belt 131 is corresponding to the tooth contour designed at the wedge-setting part 231 for providing an accurate transmission for the belt 131 located at the wedge-setting part 231. And, the reverse hook 232 is to provide a placing-in for the belt 131. Therefore, when the shaft sleeve 20 of a scanner is connected with the optical chassis 14, by the actuation of the driving device 13, the optical chassis 14 may be moved synchronically with the shaft sleeve 20 of a scanner. And, since the reverse hook 232 may provide a placing-in for the driving device 13 for preventing the transmission device 13 from dropping off due to vibration, so it may reduce the bump and separation for both the shaft sleeve 20 of a scanner and the driving device 13 during moving. And, the optical chassis 14 may make a linear displacement motion along the extension direction of the guiding rod 15 to execute a scanning motion.

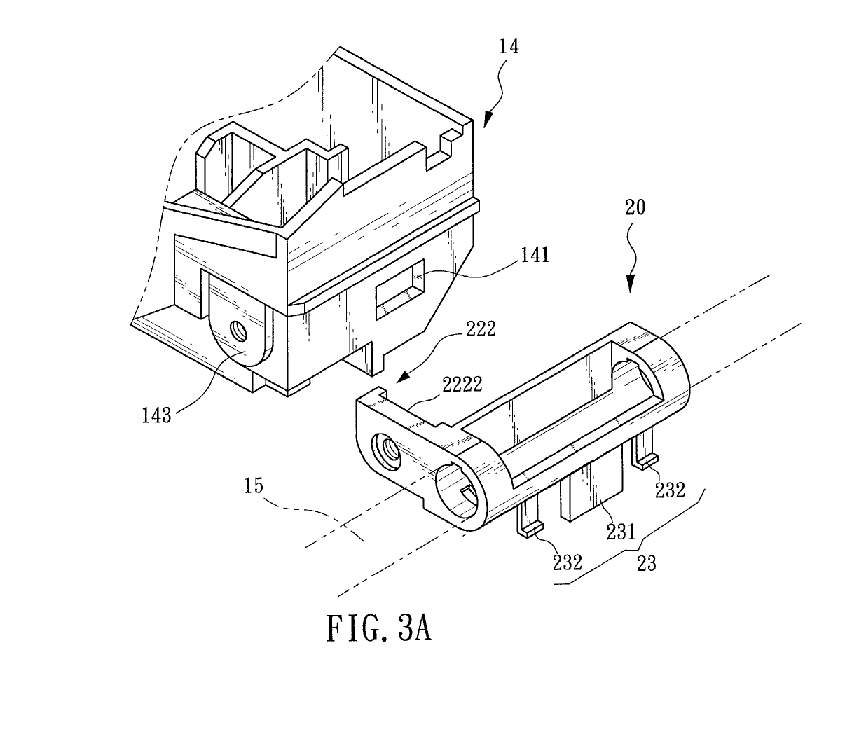

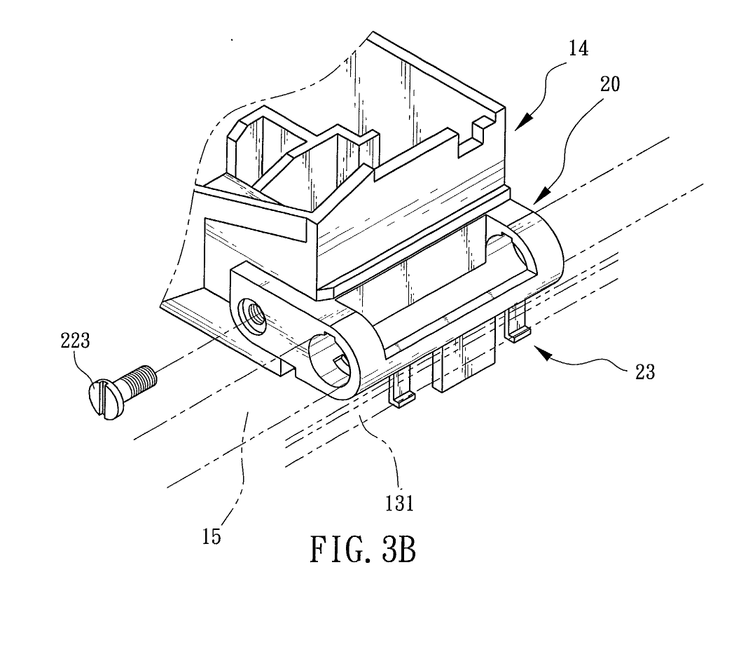

Please refer to FIG. 3A through FIG. 3B, which are the preferred implementing illustrations for the three-dimensional structures and assembling connections for another preferred embodiments for the shaft sleeve of a scanner and the scanner of the present invention. In this preferred embodiment, most elements are same as those of above-mentioned embodiments, so repetitious description is not presented any more. Herein, only the difference is addressed and described in detail. The wedging mechanism 22 is arranged at one side of the trunk 21 and may be applied to proceed the connection with the optical chassis 14. In the preferred embodiment of the invention, the wedging mechanism 22 is arranged with a protrusion-fixing part 221 and a lock-fixing part 222. The protrusion-fixing part 221 is arranged at one side of the trunk 21. The optical chassis 14 is further arranged with a recessed groove 141, of which shape is matched with the protrusion-fixing part 221 and may provide the setting-in for the protrusion-fixing part 221. The protrusion-fixing part 221 is wedged and connected with the optical chassis 14 by setting itself into the recessed groove 141. And, the lock-fixing part 222 is extended through out one side of the trunk 21 and has a recessed hole 2222. The optical chassis 14 is arranged with a corresponding protrusion edge 143. By setting the protrusion edge 143 into the recessed hole 2222, both the wedging mechanism 22 and the optical chassis 14 are positioned and connected together. Again, a bolt 223 is applied for locking and connecting both the lock-fixing part 222 and the optical chassis 14 to become one body. Such kinds of variation of structures are well known to those who are skilled in the arts and may be modified and implemented according to above disclosure without losing the merit of the present invention and departing from the spirit and scope of the present invention, so more detailed description is not repetitiously presented herein.

From above description of the shaft sleeve of a scanner of the present invention, the optical chassis may really choose a connection with the axle-sleeve device to make a linear displacement motion along the extension direction of the guiding rod or the optical chassis may choose a separation from the axle-sleeve device to reach the functions of easy change during damage and modularization for convenient assembly. And, when the scanner is bumped and moved, the reverse hook may prevent the shaft sleeve of a scanner from separating apart from the driving device. The invention may really overcome the shortcomings of the prior arts and satisfy the requirement of the manufacturing industries to promote their competition abilities.

What is claimed is:

1. A shaft sleeve of a scanner, the scanner having an optical chassis that is capable of moving along the linear direction defined by a guiding rod, comprising:
a trunk having a gliding groove capable of connecting with the guiding rod;
a wedging mechanism provided at one side of the trunk, capable of connecting with the optical chassis; and
a transmission part provided on the trunk and connected with a driving device, for enabling the truck to move along the linear direction defined by the guiding rod;
Wherein, the optical chassis is capable of choosing a connection with the shaft sleeve to move along the linear direction defined by the guiding rod or the optical chassis is capable of choosing a separation from the shaft sleeve.

2. The shaft sleeve of a scanner of claim 1, wherein the wedging mechanism having a protrusion-fixing part that is provided one side of the trunk, capable of connecting with the optical chassis by setting the optical chassis into the protrusion-fixing part.

3. The shaft sleeve of a scanner of claim 2, wherein the optical chassis having a recessed groove that is provided the setting-in for the protrusion-fixing part.

4. The shaft sleeve of a scanner of claim 1, wherein the wedging mechanism having a lock-fixing part that is extended through out one side of the trunk and is capable of connecting with the optical chassis by the locking of a bolt.

5. The shaft sleeve of a scanner of claim 4, wherein the lock-fixing part having a protrusion edge that is capable of matching with a recessed hole by the optical chassis, capable of positioning and connecting with the wedging mechanism by setting the protrusion edge into the recessed hole.

6. The shaft sleeve of a scanner of claim 4, wherein the lock-fixing part having a recessed hole that is capable of matching with a protrusion edge by the optical chassis, capable of positioning and connecting with the wedging mechanism by setting the protrusion edge into the recessed hole.

7. The shaft sleeve of a scanner of claim 1, wherein the transmission part, comprising:
a wedge-setting part provided at one side of the trunk, capable of protruding out the trunk to be able to provide the connection for the driving device; and
at least one reverse hook, which is kept an appropriate distance with the wedge-setting part to be able to provide the placing-in for the driving device.

8. The shaft sleeve of a scanner of claim 7, wherein the reverse hook is designed as an “L” shape and provide the wedge-fixing for the driving device.

9. The shaft sleeve of a scanner of claim 1, wherein the driving device is a belt.
